(19) United States
(12) Patent Application Publication
(10) Pub. No.: US 2010/0191740 A1
(43) Pub. Date: Jul. 29, 2010

(54) SYSTEM AND METHOD FOR RANKING WEB SEARCHES WITH QUANTIFIED SEMANTIC FEATURES

(75) Inventors: Yumao Lu, San Jose, CA (US); Benoit Dumoulin, Palo Alto, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/360,016

(22) Filed: Jan. 26, 2009

(51) Int. Cl. G06F 17/30

(52) U.S. Cl. 707/748; 707/E17.014; 707/E17.017; 707/E17.008; 707/E17.108

(57) ABSTRACT

A system and method for ranking web searches with quantified semantic features. A query for a web search is received from a user. The query is segmented and tagged into one or more linguistic segments using linguistic analysis. At least some of the linguistic segments are tagged with a linguistic type. A query execution plan is generated comprising the linguistic segments and, for each of the linguistic segments tagged with a linguistic type, at least one tag attribute comprising at least one domain specific feature of the linguistic type. A search is performed for documents matching the query. Each of the documents is scored for each of the linguistic segments of the query execution plan using the tag attributes of the respective linguistic segment. The documents are ranked using a function that uses the scores of the documents. A ranked list of the documents is transmitted back to the user.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for improving ranking of results returned by web searches and, more particularly, to systems and methods improving ranking of results returned by web searches using semantic analysis and scoring.

### BACKGROUND OF THE INVENTION

In a typical web query, a user enters in an unstructured string of words or other tokens relating to one or more topics of interest to the user. Web search engines typically treat the query simply as a bag of words for the selection and ranking of content. A human can readily recognize, however, that the words in the query may relate to ideas or entities that occupy a specific linguistic domain. For example, a query may contain terms that refer to, for example, people, places, businesses or other types of linguistic domains.

Such information is potentially useful, and can be used for, among other things, ranking information in search results. Most existing information retrieval models have not, however, taken full advantage of output of advanced natural language processing techniques. The linguistic types of concepts within web queries, such as business name, locations, person name, intent word, etc. and their dependency are often ignored for computing simplicity.

### SUMMARY OF THE INVENTION

In one embodiment, the invention is a method. A query for a web search is received from a user, via a network, wherein the query comprises a plurality of query tokens. The query is segmented and tagged into one or more linguistic segments using linguistic analysis performed on at least one computing device. Each linguistic segment comprises a term comprising one or more of the query tokens. At least some of the linguistic segments are further tagged with a linguistic type. A query execution plan is generated on the computing device. The query execution plan comprises the linguistic segments. For each of the linguistic segments tagged with a linguistic type, the query execution plan further comprises at least one tag attribute comprising at least one domain specific feature of the linguistic type of its respective linguistic segment. A search is performed for plurality of documents matching the query using the computing device. The plurality of documents are scored, using the at least one computing device, wherein each of the plurality of documents is scored for each of the linguistic segments of the query execution plan using the tag attributes of the respective linguistic segment. The plurality of documents are ranked, using the at least one computing device. The plurality of documents are ranked using a function that uses the scores of the documents to determine the rank of the respective document. A list of the of the plurality of documents in rank order is transmitted, over the network, to the user.

In another embodiment, the invention is a system. The system comprises: a query receiving module that receives queries for a web searches from users, via a network, wherein each query comprises a plurality of query tokens; a linguistic analysis module that segments and tags each query received by the query receiving module into one or more linguistic segments using linguistic analysis, wherein each linguistic segment comprises a term comprising one or more of the query tokens of the respective query, and wherein at least some of the linguistics segments are further tagged with a linguistic type; a query execution plan generation module that generates query execution plans for each query processed by the linguistic analysis module, wherein each query execution plan comprises the linguistic segments of the respective query, and wherein for each of the segments tagged with a linguistic type, the plan further comprises at least one tag attribute comprising at least one domain specific feature of the linguistic type of its respective linguistic segment; a search module that searches, for each query processed by the query execution plan generation module, for a plurality of documents matching the respective query; a document scoring module that scores, for every query processed by the search module, the respective plurality of documents, wherein each of the plurality of documents is scored for each of the linguistic segments of the respective query execution plan using the tag attributes of the respective linguistic segment; a document ranking module that ranks, for every query processed by the search module, the respective plurality of documents, wherein the plurality of documents are ranked by a function which uses the scores calculated by the document scoring module of the respective documents to determine the rank of the respective documents; and a results transmission module that transmits, for each plurality of documents ranked by the document ranking module, a list of the respective plurality of documents in rank order, over the network, to a user that submitted the query.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a high-level diagram of one embodiment of a system providing web search capabilities with search result ranking using quantified semantic features.

FIG. 2 illustrates one embodiment of a process for ranking web searches with quantified semantic features.

FIG. 3 illustrates one embodiment of a query linguistic analysis engine and a search engine capable of supporting at least one embodiment of the process shown in FIG. 2.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The present invention is directed to systems and methods for improved ranking of results returned by web searches using semantic analysis and scoring, as described in more detail below.

Embodiments of this invention create a nexus between natural language processing techniques and information retrieval systems by using semantic type dependent text matching techniques which can be adapted for large scale industrial information retrieval systems. In at least one embodiment of the system, such features are not based on statistics of the nth term, nth term pair, or nth concept, etc. of a user query in a document, but based on the statistics of type t concept for semantic term group types. These semantic features can be modeled such that they not only measure type specific term proximity, but also convey domain knowledge to information retrieval models.

Linguistic analysis, such as advanced natural language processing (NLP) techniques, can be applied to both query modeling and document indexing. In one embodiment, the output of linguistic analysis are linguistic segments comprising terms (which may comprise one or more words) and associated types, such as entity tags and part-of-speech tags. Intuitively, the type attribute of a term identified in a user query conveys critical information that is more than just proximity. First, the type attribute is related to user intent. For example, when a query is a business category plus a location, such as “hotels Palo Alto”, the user most likely wishes to see a page contains a list of hotels in Palo Alto. When a query is a business name plus a location, such as “Fuki Sushi Palo Alto”, the user's major intent is to look for the home page of a specific business home page.

Second, document relevance depends on both term group statistics and term group type. For example, if “Palo Alto” appears three times in a document body text, the document is more likely to be a local listing page than a home page for a business. For the query “hotels Palo Alto” a local listing page may be a good page, while for query “Fuki Sushi Palo Alto” a local listing page is not a good page.

Third, the type attribute conveys domain information. A domain specific corpus can be used to provide additional information. For example, a brand term is in general more important than other terms in a business name, such as “yahoo” in “yahoo inc” and “kaiser” in “kaiser medical service” etc. The likelihood a term is a brand name can be characterized by the term frequency in a business name database. For example, in a business name data base, “yahoo” appears 11 times while “inc” appears 92038 times. Thus, empirically, “yahoo” is probably a brand term and “inc” is not. This kind of information is not available before looking at a domain database (e.g. a business name database.)

Fourth, different types of terms can have different proximity features. For example, for an entity type like city name, “River Side”, the proximity requirement is high; no word is allowed to be in between words within the term and in the same order. For other types of entities, such as personal name, the proximity constraint can be relaxed somewhat since documents personal names may contain one or more, or no, middle names and may be represented last name (surname) first, or first name (given name) first.

The information provided by linguistic analysis of web search queries can be used, among other things, to enhance the results of web searches by ranking the results using terms and their associated types. In one embodiment, the information provided by linguistic analysis of a web query can be reflected in a query execution plan that includes quantified semantic features within the query, as described below, which is used by a web search server to score and rank documents returned by a web search.

In one embodiment, a query execution plan could take the general form of one or more linguistic segments. Each segment comprises a term that can be tagged or untagged. Where a term is tagged, the query execution plan can additionally include one or more tag attributes for that term, which may include quantified semantic features of the term. A tagged term with tag attributes could be expressed as follows:

tag[type=value, cfd=value, weights=(value1, . . . value n)]{term}

where:
type is a linguistic type, such as an entity type or a part of speech (e.g. personal name, business name, etc.)
cfd is an attribute that expresses the confidence that the term is the tagged type, which in one embodiment, can be expressed as a fraction of 1.0 (e.g. 0.7=70% confidence the term is the tagged type.)
weights is an attribute that expresses the relative weights to be assigned to individual words within a term (i.e. the most important words in a term have the highest weights.)
term is the actual value of the search term, which, in one embodiment, can comprise one or more words.

For example, a query like “james bond breaks bank of america” could have the following execution plan:

tag[type=person_name, cfd=0.9]{james bond} breaks tag[type=biz_name, cfd=0.95, weights=“0.3,0.1,0.7”]{bank of america}

The first linguistic segment is a tagged term “james bond”, which has been tagged as a personal name. There is a cfd (confidence) attribute associated with the term that indicates it is 90% certain that the term is a personal name. The second linguistic segment is an untagged term “breaks.” The third linguistic segment is a tagged term “bank of america”, which has been tagged as a business name. There is a cfd (confidence) attribute associated with the term that indicates it is 95% certain that the term is a business name. There is also a weight attribute that indicates the three words within the term have a relative importance of 0.3, 0.1, and 0.7 respectively. The weight attribute is, in one embodiment, the inverse document frequencies (idf) of each word in the term.

The query execution plan syntax shown above is intended to be illustrative, and not limiting. Those skilled in the art will readily appreciate that the same information could be represented in a number of different forms, all of which are intended to be within the scope of this disclosure.

In one embodiment, the initial linguistic analysis, segmentation and tagging of a query can be performed using any linguistic analysis techniques known in the art, such as advanced natural language processing techniques. The output of such analysis and segmentation for a query are one or query segments. Each segment comprises a search term and can additionally include a tag indicating the linguistic type of the term.

Tag attributes for each tagged term can then be retrieved from one or more vertical databases, where each database comprises attribute information relating to a specific linguistic type. For example, with reference to the example above, there could be one vertical database for personal names, and another for business names. In one embodiment, each vertical database can comprise confidence and weight information for specific terms within the domain of the vertical database. The vertical databases can be created using any technique known in the art suitable for such application. In one embodiment, the vertical databases are created by manually editing data extracted from one or more query logs from a commercial search engine and loading the data into a database. For example, a human editor could identify business names in query log containing a random selection of queries executed on a given day and confidence and weight attributes could be then be determined by statistical analysis of such data.

When a query is executed by a search engine, a query execution plan containing quantified semantic information for the query can be used to score documents within the search results using techniques that take advantage of the quantified semantic information within the plan. Three such techniques are which can be used Semantic Minimum Coverage (SMC), Semantic Moving Average BM25 (SMABM25), and Vertical Moving Average BM25 (VMABM25), embodiments of which are illustrated below.

In one embodiment, documents within the search results are scored separately for each query segment. In one embodiment, a different scoring methodology is used for one or more segments. In one embodiment, a document can be scored using multiple scoring methodologies.

Note that each of these techniques is used to score a document for individual tagged segments within a query execution plan. Thus, where a query execution plan contains two tagged segments (e.g. person_name and biz_name), each document receives at least two scores, one for each segment.

### Semantic Minimum Coverage (SMC)

Minimum coverage (mc) is a span based proximity distance measure, which is defined as the length of the shortest document segment that covers the query term at least once in a document. Semantic Minimum Coverage (smc) for a semantic type t in a document or document segment s can be defined as

$${smc}_{t , s} = \frac{1}{\vert \{ k \vert {T}_{k} = t \} \vert} {\sum }_{i ∈ \{ k \vert {T}_{k} = t \}} {w}_{i} m {c}_{i , s} ,$$

where wᵢ is a weight for tagged term i, mc_{i,s} is the minimum coverage of term i in a document or document segment s, {k|Tₖ=t} denotes the set of all terms having type t and |{k|Tk=t}| denotes the size of the set.

### Semantic Moving Average BM25 (SMABM25)

A BM25 type of score is bag-of-words relevance metric. In one embodiment, a BM25 metric can be defined as:

$$BM 25 = {\sum }_{j} {idf}_{j} \frac{{f}_{j , s} ( c 1 + 1 )}{{f}_{i , s} + {c}_{1} ( 1 - c 2 + c 2 \frac{{l}_{s}}{c {3}_{s}}} )$$

Where f_{j,s} the frequency of term j in a document or document segment s, lₛ is the length of document s, c1, c2, c3 are constants and the inverse document frequency (idf) score of term j is defined as:

$${idf}_{j} = log \frac{c 4 - {d}_{i} + c 5}{{d}_{i} + c 5} ,$$

where dᵢ is the number of documents in all collections that contains term j and c4, c5 are constants.

To characteristic proximity, we could use a fixed-length moving window and calculate the average BM25. We could further associate each moving average BM25 with each type of semantic term. The semantic moving average BM25 (MABM25) of type t could be defined as follows:

$$MABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m}$$

where {k|Tₖ=t} denotes the set of all terms having type t and |{k|Tk=t}| denotes the size of the set, m is a fixed length moving window m, and M is the total number of moving windows that can depend on the length of the document and the moving step size.

### Vertical Moving Average BM25 (VMABM25)

The vertical moving average BM25 take advantage of the vertical knowledge for in scoring search results.

$$VMABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m , t} \\ where \\ BM {25}_{m , t} = {\sum }_{j} {idf}_{j}^{t} \frac{{f}_{j , s} ( c 1 + 1 )}{{f}_{i , s} + {c}_{1} ( 1 - c 2 + c 2 \frac{{l}_{s}}{c {3}_{s}}} )$$

where the idf^{t}ⱼ is inverse document frequency for a term which has been determined using information retrieved from the vertical database for type t. VMVBM25 is a metric that links vertical knowledge, proximity, and page relevance together.

Once documents in a search result have been scored, they can be ranked using a ranking function that uses document scores computed for a document. In one embodiment, the ranking function could be an unweighted sum of all of the scores computed for a document. In one embodiment, the ranking function could be a weighted sum, where scores for specific types of linguistic segments could be weighted more heavily. In one embodiment, the ranking function could be a classifier, (e.g. an SVM) that was trained using a manually labeled training data set.

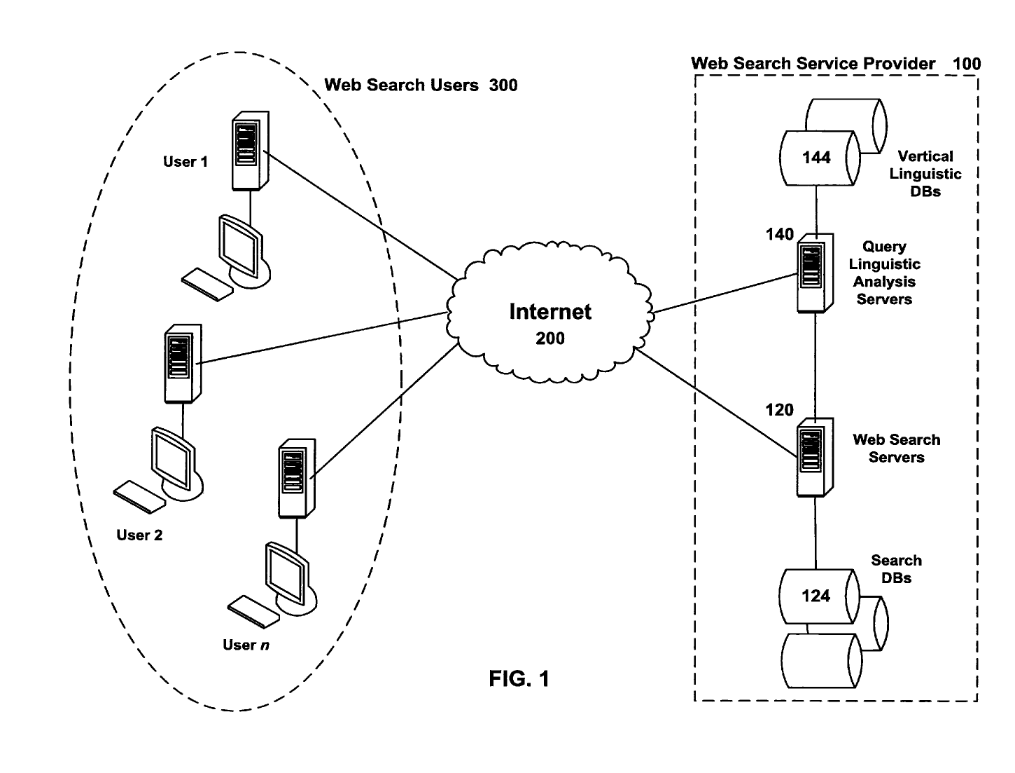

FIG. 1 is a high-level diagram of one embodiment of a system providing web search capabilities with search result ranking using quantified semantic features.

A service provider 100 provides web search services including methods for ranking web searches with quantified semantic features as described herein. Web search services are supported by one or more web search servers 120. The web search services can include conventional web search services such as that currently provided by, for example, Yahoo! and Google, and can also include enhanced services, such as ranking by quantified semantic features using query execution plans comprising quantified semantic features for specific queries. The servers 120 are operatively connected to storage devices 124 that can support various databases for supporting web search services such as, for example, directories or indexes.

Query linguistic analysis services are provided by one or more query linguistic analysis servers 140. Services provided by query linguistic analysis servers can include segmenting and tagging web search queries submitted by users into one or more linguistic segments, as well as generating query execution plans comprising quantified semantic features for specific queries. The servers 140 are operatively connected to storage devices 144 which can support various databases for supporting the generation of query execution plans, including vertical linguistic databases, each of which comprise data relating to a single linguistic domain. In the illustrated embodiment, the servers providing linguistic analysis services 140 services are shown as a separate cluster of servers from those providing web search services 120, however it should be understood that a single server or cluster of server could support web search services and query rewriting services such as those discussed herein.

The servers providing web search services 120 and linguistic analysis services 140 are operatively connected to each other and are further connected to an external network such as, for example, the Internet 200. Via the Internet 200, one or more users 300 are operatively connected to the servers 120 and 140, and can access services available on such servers. Users 200 can, inter alia, enter web queries using their respective computing devices. The system can be configured such that queries are initially submitted to web search service servers 120, which can then forward the query to query linguistic analysis servers 140 for linguistic analysis. Alternatively, the system can be configured such that queries are submitted initially to query linguistic analysis servers 140, which can perform linguistic analysis on the queries and then forward the queries and their respective execution plans to web search service servers 120.

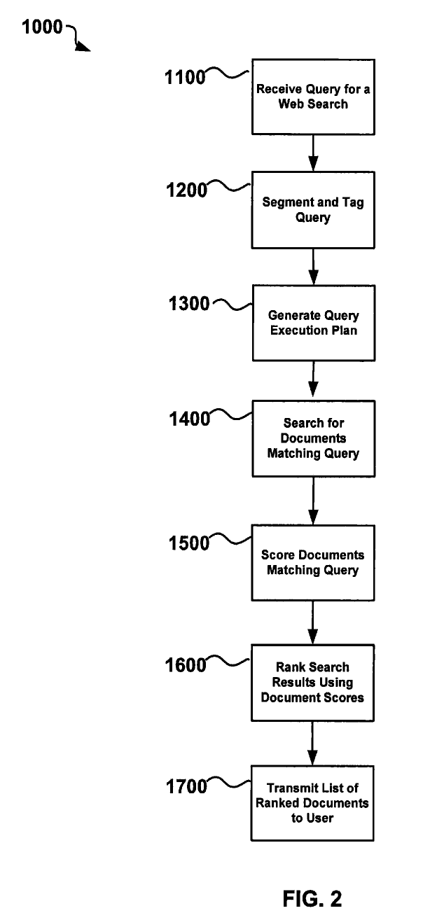

FIG. 2 illustrates one embodiment of a process for ranking web searches with quantified semantic features.

The process begins when a web search query is received 1100 from a user, via a network at, for example, a server providing web search services. The query comprises a plurality of query tokens. In a typical web query, the tokens will be words, but they may also could also be any other symbol which has meaning to the user entering the query. The user may have entered the query from any device having access to the network such as, for example, desktop computers, laptop computers, PDAs, cell phones and so forth.

The query is then segmented and tagged 1200 using linguistic analysis performed by at least one computing device. In one embodiment, linguistic analysis of the query is performed by a query linguistic analysis server. In one embodiment, the initial linguistic analysis, segmentation and tagging of a query can be performed using any linguistic analysis techniques known in the art, such as advanced natural language processing techniques. Each linguistic segment comprises a search term comprising one or more of the query tokens. At least some of the linguistics segments are further tagged with a linguistic type (i.e. personal name, business name.)

A query execution plan is then generated 1300 from the segmented and tagged query by a computing device. In one embodiment, query execution plan generation is performed by a query linguistic analysis server. The query execution plan includes the linguistic segments identified within the segmented and tagged query. For each of the linguistic segments tagged with a linguistic type, the query execution plan further includes at least one tag attribute comprising at least one domain specific feature of the linguistic type of its respective linguistic segment.

In one embodiment, each of the features specific to the domain of the linguistic type of a linguistic segment is retrieved from one of a plurality of vertical databases. Each of the vertical databases comprises data related a specific linguistic type (e.g. person name, business name, and so forth.)

In one embodiment, at least one of the domain specific features comprises a confidence level or a weight attribute. In one embodiment, each vertical database can comprise confidence and weight information for specific terms within the domain of the vertical database. In one embodiment, confidence is expressed as a fraction of 1.0 (e.g. 0.7=70% confidence the term is the tagged type.) In one embodiment, the weight is expressed as string of one or more inverse document frequencies, where each inverse document frequency is the inverse document frequency of one of the query tokens within the segment (e.g. weights=“0.3,0.1,0.7” for “bank of america”: “bank”=0.3; “of”=0.1″, “america”=0.7.)

In one embodiment, the query execution plan includes one or more segments having the general format:

tag[type=value, cfd=value, weights=(value1, . . . value n)]{term}

where:
type is a linguistic type
cfd is the confidence that the term is the tagged type
weights are the relative weights to be assigned to individual words within a term.
term is the actual value of the search term.

A search is then performed 1400, using a computing device, for a plurality of documents matching the query. In one embodiment, the search is performed by a web search server using conventional search techniques well known in the art. In one embodiment, the search is performed using the query only. In one embodiment, the search is performed using the query execution plan. In one embodiment, the search is performed using the query and the query execution plan. The documents matched by the query can be on local storage operatively connected to the computing device, or can be located on a remote server or storage device accessible to the network.

The plurality of documents matched by the search step are then scored 1500, using a computing device. In one embodiment, scoring is performed by the web search server that performed the search step. In one embodiment, each of the plurality of documents is scored for each of the linguistic segments of the query execution plan using the tag attributes of the respective linguistic segment. Scoring methodologies can include, without limitation, the frequency of linguistic segments within a document, the normalized frequency of linguistic segments within a document, the semantic minimum coverage of linguistic segments within a document, the semantic moving average BM25 of linguistic segments within a document or the vertical moving average BM25 of linguistic segments within a document.

In one embodiment, documents within the search results are scored separately for each query segment. In one embodiment, a different scoring methodology is used for one or more segments. In one embodiment, a document can be scored using multiple scoring methodologies.

The plurality of documents scored by the scoring step are then ranked 1600 using a computing device. In one embodiment, scoring is performed by the web search server that performed the search step. In one embodiment, the plurality of documents are ranked by a function which uses the scores of the respective documents to determine the rank of the respective documents.

In one embodiment, the ranking function could be an unweighted sum of all of the scores computed for a document. In one embodiment, the ranking function could be a weighted sum, where scores for specific types of linguistic segments could be weighted more heavily. In one embodiment, the ranking function could be a classifier, (e.g. an SVM) that was trained using a manually labeled training data set.

Finally, a list of the plurality of documents in rank order is transmitted 1700, over the network, to the querying user. In one embodiment, the list is a conventional web search result page, where documents are listed as text entries with hyperlinks to actual documents.

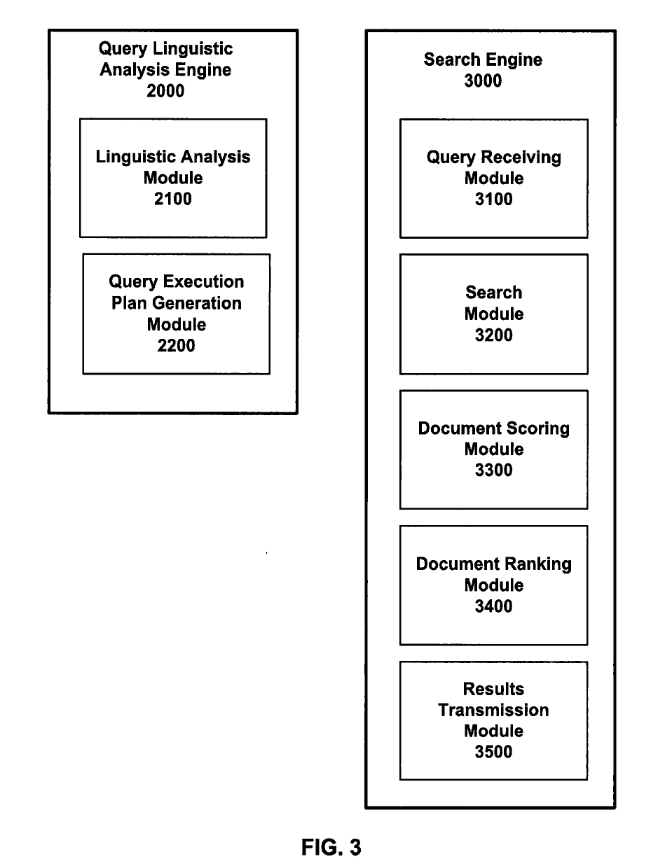

FIG. 3 illustrates one embodiment of a query linguistic analysis engine 2000 and a search engine 3000 capable of supporting at least one embodiment of the process shown in FIG. 2.

The query linguistic analysis engine 2000 comprises a linguistic analysis module 2100 and a query execution plan generation module 2200. The search engine 3000 comprises a query receiving module 3100, a search module 3200, a document scoring module 3300, a document ranking module 3400 and a results transmission module 3500.

The engines 2000 and 3000 could each be implemented on one or more servers or other computing devices. For example, with respect to FIG. 1, the query linguistic analysis engine 2000 could be implemented on the query linguistic analysis servers 140, and the search engine 3000 could be implemented on the web search servers 120. As noted above with respect to FIG. 1, all of these functions and engines could also consolidated in a single server or cluster of servers, or alternatively, each module could each be implemented on a single server or cluster of servers.

Referring back to FIG. 3, the query receiving module 3100 is configured to receive web search queries from users. The queries comprise a plurality of query tokens. In a typical web query, the tokens will be words, but they may also could also any other symbol which has meaning to the user entering the query. The user may have entered the query from any device having access to the network such as, for example, desktop computers, laptop computers, PDAs, cell phones and so forth.

The linguistic analysis module 2100 is configured to segment and tag each query received by the query receiving module into one or more linguistic segments using linguistic analysis. Each linguistic segment comprises a term comprising one or more of the query tokens of the respective query. At least some of the linguistics segments are further tagged with a linguistic type. In one embodiment, linguistic analysis, segmentation and tagging of a query can be performed using any linguistic analysis techniques known in the art, such as advanced natural language processing techniques.

The query execution plan generation module 2200 is configured to generate query execution plans for each query processed by the linguistic analysis module 2100. Each query execution plan comprises the one or more linguistic segments of the respective query. Where a linguistic segment is tagged with a linguistic type, the query execution plan further comprises at least one tag attribute comprising at least one domain specific feature of the linguistic type of its respective linguistic segment.

In one embodiment, each of the features specific to the domain of the linguistic type of a linguistic segment is retrieved from one of a plurality of vertical databases accessible over the network. Each of the vertical databases comprises data related a specific linguistic type (e.g. person name, business name, and so forth.)

In one embodiment, at least one of the domain specific features comprises a confidence level or a weight attribute. In one embodiment, each vertical database can comprise confidence and weight information for specific terms within the domain of the vertical database. In one embodiment, the query execution plan includes one or more segments having the general format:

tag[type=value, cfd=value, weights=(value1, . . . value n)]{term}

where:
type is a linguistic type
cfd is the confidence that the term is the tagged type,
weights is the relative weights to be assigned to individual words within a term,
term is the actual value of the search term.

The search module 3200 is configured to search, for each query processed by the query execution plan generation module 2200, for a plurality of documents matching the respective query. In one embodiment, the search is performed using conventional search techniques well known in the art. In one embodiment, the search is performed using the queries only. In one embodiment, searches are performed using query execution plans only. In one embodiment, searches are performed using the queries and respective query execution plans. The documents matched by the query may be on local storage, or may be located on one or more remote servers or storages device accessible to the network.

The document scoring module 3300 is configured to score, for every query processed by the search module 3200, the respective plurality of documents matching the query. Each of the plurality of documents is scored for each of the one or more linguistic segments of the respective query execution plan using the tag attributes of the respective linguistic segment. Scoring methodologies can include, without limitation the frequency of linguistic segments within a document, the normalized frequency of linguistic segments within a document, the semantic minimum coverage of linguistic segments within a document, the semantic moving average BM25 of linguistic segments within a document or the vertical moving average BM25 for of linguistic segments within a document.

In one embodiment, documents within the search results are scored separately for each query segment. In one embodiment, a different scoring methodology is used for one or more segments. In one embodiment, a document can be scored using multiple scoring methodologies.

The document ranking module 3400 is configured to rank, for every query processed by the search module, the respective plurality of documents matching the query. The plurality of documents are ranked by a function which uses the scores calculated by the document scoring module for the respective documents to determine the rank of the respective documents.

In one embodiment, the ranking function could be an unweighted sum of all of the scores computed for a document. In one embodiment, the ranking function could be a weighted sum, where scores for specific types of linguistic segments could be weighted more heavily. In one embodiment, the ranking function could be a classifier, (e.g. an SVM) that was trained using a manually labeled training data set.

The results transmission module 3500 is configured to transmit, for each plurality of documents ranked by the document ranking module, a list of the respective plurality of documents in rank order, over the network, to a user that submitted the query. In one embodiment, the list is a conventional web search result page, where documents are listed as text entries with hyperlinks to actual documents.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising the steps of:
receiving a query for a web search from a user, via a network, wherein the query comprises a plurality of query tokens;
segmenting and tagging the query, using linguistic analysis performed on at least one computing device, into one or more linguistic segments, wherein each linguistic segment comprises a term comprising one or more of the query tokens, and wherein at least some of the linguistics segments are further tagged with a linguistic type;
generating a query execution plan, on the at least one computing device, wherein the query execution plan comprises the one or more linguistic segments, and wherein for each of the one or more linguistic segments tagged with a linguistic type, the query execution plan further comprises at least one tag attribute comprising at least one domain specific feature of the linguistic type of its respective linguistic segment;
searching, using the at least one computing device, for a plurality of documents matching the query;
scoring the plurality of documents, using the at least one computing device, wherein each of the plurality of documents is scored for each of the one or more linguistic segments of the query execution plan using the at least one tag attribute of the respective linguistic segment;
ranking the plurality of documents, using the at least one computing device, wherein the plurality of documents are ranked by a function which uses the scores of the respective documents to determine the rank of the respective document;
transmitting a list of the plurality of documents in rank order, over the network, to the user.

2. The method of claim 1 wherein each of the features specific to the domain of the linguistic type of a linguistic segment are retrieved from one of a plurality of vertical databases, wherein each of the plurality of vertical databases comprises data related to a specific linguistic type.

3. The method of claim 2 wherein the at least one of the domain specific features is selected from the list: confidence level, weight.

4. The method of claim 2 wherein the at least one of the domain specific features comprises confidence level and weight.

5. The method of claim 2 wherein for each linguistic segment having a domain specific feature of weight, the weight is expressed in the query execution plan as one or more inverse document frequencies, where each inverse document frequency is the inverse document frequency of one of the one or more query tokens comprising the term in the segment.

6. The method of claim 1 wherein each of the plurality of documents is scored using at least one scoring methodology selected from the list: frequency of linguistic segments, normalized frequency of linguistic segments, semantic minimum coverage of linguistic segments, the semantic moving average BM25 of linguistic segments, the vertical moving average BM25 of linguistic segments.

7. The method of claim 1 wherein each of the plurality of documents is scored using semantic minimum coverage for each linguistic segment within the query execution plan, wherein the formula for calculating semantic minimum coverage is:
$${smc}_{t , s} = \frac{1}{\vert \{ k \vert {T}_{k} = t \} \vert} {\sum }_{i ∈ \{ k \vert {T}_{k} = t \}} {w}_{i} m {c}_{i , s} ,$$
where wᵢ is a weight for the term i, mc_{i,s} is the minimum coverage of the term i in a document s, {k|Tₖ=t} denotes the set of all terms having type t and |{k|Tk=t}| is the size of the set.

8. The method of claim 1 wherein each of the plurality of documents is scored using semantic moving average for each linguistic segment within the query execution plan, wherein the formula for calculating semantic moving average is:
$$MABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m}$$
where {k|Tₖ=t} denotes the set of all terms having type t and |{k|Tk=t}| denotes the size of the set, m is a fixed length moving window m, and M is the total number of moving windows that depends on length of the document and the moving step size,
where
$$BM 25 = {\sum }_{j} {idf}_{j} \frac{{f}_{j , s} ( c 1 + 1 )}{{f}_{i , s} + {c}_{1} ( 1 - c 2 + c 2 \frac{{l}_{s}}{c {3}_{s}}} )$$
Where f_{j,s} the frequency of term j in a document s, lₛ is the length of document s, c1, c2, c3 are constants and the inverse document frequency (idf) score of term j is defined as:
$${idf}_{j} = log \frac{c 4 - {d}_{i} + c 5}{{d}_{i} + c 5} ,$$
where dᵢ is the number of documents in all collections that contains term j and c4, c5 are constants.

9. The method of claim 2 wherein each of the plurality of documents is scored using vertical moving average for each linguistic segment within the query execution plan, wherein the formula for calculating vertical moving average is:
$$VMABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m , t} \\ where \\ BM {25}_{m , t} = {\sum }_{j} {idf}_{j}^{t} \frac{{f}_{j , s} ( c 1 + 1 )}{{f}_{i , s} + c 1 ( 1 - c 2 + c 2 \frac{{l}_{s}}{c {3}_{s}}} )$$
where the idf^{t}ⱼ is inverse document frequency for a term determined using information retrieved from the one of the plurality of vertical databases for type t and c1 and c2 are constants.

10. A system comprising:
a query receiving module that receives queries for a web searches from users, via a network, wherein each query comprises a plurality of query tokens;
a linguistic analysis module that segments and tags each query received by the query receiving module into one or more linguistic segments using linguistic analysis, wherein each linguistic segment comprises a term comprising one or more of the query tokens of the respective query, and wherein at least some of the linguistics segments are further tagged with a linguistic type;
a query execution plan generation module that generates query execution plans for each query processed by the linguistic analysis module, wherein each query execution plan comprises the one or more linguistic segments of the respective query, and wherein for each of the one or more linguistic segments tagged with a linguistic type, the query execution plan further comprises at least one tag attribute comprising at least one domain specific feature of the linguistic type of its respective linguistic segment;
a search module that searches, for each query processed by the query execution plan generation module, for a plurality of documents matching the respective query;
a document scoring module that scores, for every query processed by the search module, the respective plurality of documents, wherein each of the plurality of documents is scored for each of the one or more linguistic segments of the respective query execution plan using the at least one tag attribute of the respective linguistic segment;
a document ranking module that ranks, for every query processed by the search module, the respective plurality of documents, wherein the plurality of documents are ranked by a function which uses the scores calculated by the document scoring module of the respective documents to determine the rank of the respective documents;
a results transmission module that transmits, for each plurality of documents ranked by the document ranking module, a list of the respective plurality of documents in rank order, over the network, to a user that submitted the query.

11. The system of claim 10 wherein each of the features specific to the domain of the linguistic type of a linguistic segment are retrieved from one of a plurality of vertical databases, wherein each of the plurality of vertical databases comprises data related to a specific linguistic type.

12. The system of claim 11 wherein the at least one of the domain specific features is selected from the list: confidence level, weight.

13. The system of claim 11 wherein the at least one of the domain specific features comprises confidence level and weight.

14. The system of claim 11 wherein for each linguistic segment having a domain specific feature of weight, the weight is expressed in the query execution plan as one or more inverse document frequencies, where each inverse document frequency is the inverse document frequency of the one of the one or more query tokens comprising the term in the respective segment.

15. The system of claim 10 wherein each of the plurality of documents is scored by the document scoring module using at least one scoring methodology selected from the list: frequency of linguistic segments, normalized frequency of linguistic segments, semantic minimum coverage of linguistic segments, the semantic moving average BM25 of linguistic segments, the vertical moving average BM25 of linguistic segments within the document.

16. The system of claim 10 wherein each of the plurality of documents is scored by the document scoring module using semantic minimum coverage for each linguistic segment within the query execution plan, wherein the formula for calculating semantic minimum coverage is:
$${smc}_{t , s} = \frac{1}{\vert \{ k \vert {T}_{k} = t \} \vert} {\sum }_{i ∈ \{ k \vert {T}_{k} = t \}} {w}_{i} m {c}_{i , s} ,$$
where wᵢ is a weight for the term i, mc_{i,s} is the minimum coverage of the term i in a document s, {k|Tₖ=t} denotes the set of all terms having type t and |{k|Tk=t}| is the size of the set.

17. The system of claim 10 wherein each of the plurality of documents is scored by the document scoring module using semantic moving average for each linguistic segment within the query execution plan, wherein the formula for calculating semantic moving average is:
$$MABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m}$$
where {k|Tₖ=t} denotes the set of all terms having type t and |{k|Tk=t}| denotes the size of the set, m is a fixed length moving window m, and M is the total number of moving windows that depends on length of the document and the moving step size,
where
$$BM 25 = {\sum }_{j} {idf}_{j} \frac{{f}_{j , s} ( c 1 + 1 )}{{f}_{i , s} + {c}_{1} ( 1 - c 2 + c 2 \frac{{l}_{s}}{c {3}_{s}}} )$$
Where f_{j,s} the frequency of term j in a document s, lₛ is the length of document s, c1, c2, c3 are constants and the inverse document frequency (idf) score of term j is defined as:
$${idf}_{j} = log \frac{c 4 - {d}_{i} + c 5}{{d}_{i} + c 5} ,$$
where dᵢ is the number of documents in all collections that contains term j and c4, c5 are constants.

18. The system of claim 11 wherein each of the plurality of documents is scored by the document scoring module using vertical moving average for each linguistic segment within the query execution plan, wherein the formula for calculating vertical moving average is:
$$VMABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m , t} \\ where \\ BM {25}_{m , t} = {\sum }_{j} {idf}_{j}^{t} \frac{{f}_{j , s} ( c 1 + 1 )}{{f}_{i , s} + {c }_{1} ( 1 - c 2 + c 2 \frac{{l}_{s}}{c {3}_{s}}} )$$
where the idf^{t}ⱼ is inverse document frequency for a term determined using information retrieved from the one of the plurality of vertical databases for type t and c1 and c2 are constants.

19. A computer-readable medium having computer-executable instructions for a method comprising the steps of:
receiving a query for a web search from a user, via a network, wherein the query comprises a plurality of query tokens;
segmenting and tagging the query, using linguistic analysis performed on at least one computing device, into one or more linguistic segments, wherein each linguistic segment comprises a term comprising one or more of the query tokens, and wherein at least some of the linguistics segments are further tagged with a linguistic type;
generating a query execution plan, on the at least one computing device, wherein the query execution plan comprises the one or more linguistic segments, and wherein for each of the one or more linguistic segments tagged with a linguistic type, the query execution plan further comprises at least one tag attribute comprising at least one domain specific feature of the linguistic type of its respective linguistic segment;
searching, using the at least one computing device, for a plurality of documents matching the query;
scoring the plurality of documents, using the at least one computing device, wherein each of the plurality of documents is scored for each of the one or more linguistic segments of the query execution plan using the at least one tag attribute of the respective linguistic segment;
ranking the plurality of documents, using the at least one computing device, wherein the plurality of documents are ranked by a function which uses the scores of the respective documents to determine the rank of the respective document;
transmitting a list of the plurality of documents in rank order, over the network, to the user.

20. The method of claim 19 wherein each of the features specific to the domain of the linguistic type of a linguistic segment are retrieved from one of a plurality of vertical databases, wherein each of the plurality of vertical databases comprises data related to a specific linguistic type.

21. The method of claim 20 wherein the at least one of the domain specific features is selected from the list: confidence level, weight.

22. The method of claim 20 wherein the at least one of the domain specific features comprises confidence level and weight.

23. The method of claim 20 wherein for each linguistic segment having a domain specific feature of weight, the weight is expressed in the query execution plan as one or more inverse document frequencies, where each inverse document frequency is the inverse document frequency of the one of the one or more query tokens comprising the term in the segment.

24. The method of claim 19 wherein each of the plurality of documents is scored using at least one scoring methodology selected from the list: frequency of linguistic segments, normalized frequency of linguistic segments, semantic minimum coverage of linguistic segments, the semantic moving average BM25 of linguistic segments, the vertical moving average BM25 of linguistic segments.

25. The method of claim 19 wherein each of the plurality of documents is scored using semantic minimum coverage for each linguistic segment within the query execution plan, wherein the formula for calculating semantic minimum coverage is:
$${smc}_{t , s} = \frac{1}{\vert \{ k \vert {T}_{k} = t \} \vert} {\sum }_{i ∈ \{ k \vert {T}_{k} = t \}} {w}_{i} m {c}_{i , s} ,$$
where wᵢ is a weight for the term i, mc_{i,s} is the minimum coverage of the term i in a document s, {k|Tₖ=t} denotes the set of all terms having type t and |{k|Tk=t}| is the size of the set.

26. The method of claim 19 wherein each of the plurality of documents is scored using semantic moving average for each linguistic segment within the query execution plan, wherein the formula for calculating semantic moving average is:
$$MABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m}$$
where {k|Tₖ=t} denotes the set of all terms having type t and |{k|Tk=t}| denotes the size of the set, m is a fixed length moving window m, and M is the total number of moving windows that depends on length of the document and the moving step size,
where
$$BM 25 = {\sum }_{j} {idf}_{j} \frac{{f}_{j , s} ( c 1 + 1 )}{{f}_{i , s} + {c}_{1} ( 1 - c 2 + c 2 \frac{{l}_{s}}{c {3}_{s}}} ) .$$
Where f_{i,s} the frequency of term j in a document s, lₛ is the length of document s, c1, c2, c3 are constants and the inverse document frequency (idf) score of term j is defined as:
$${idf}_{j} = log \frac{c 4 - {d}_{i} + c 5}{{d}_{i} + c 5} ,$$
where dᵢ is the number of documents in all collections that contains term j and c4, c5 are constants.

27. The method of claim 20 wherein each of the plurality of documents is scored using vertical moving average for each linguistic segment within the query execution plan, wherein the formula for calculating vertical moving average is:
$$VMABM {25}_{t} = \frac{1}{\vert \{ k \vert {T}_{k} = t \} \vert} {\sum }_{i ∈ \{ k \vert {T}_{k} = t \}} ( 1 / M ) {\sum }_{m} BM {25}_{m , t} \\ where \\ BM {25}_{m , t} = {\sum }_{j} {idf}_{j}^{t} \frac{{f}_{j , s} ( c 1 + 1 )}{{f}_{i , s} + {c}_{1} ( 1 - c 2 + c 2 \frac{{l}_{s}}{c {3}_{s}}} )$$
where the idf^{t}ⱼ is inverse document frequency for a term determined using information retrieved from the one of the plurality of vertical databases for type t and c1 and c2 are constants.
